(19) United States
(12) Patent Application Publication
(10) Pub. No.: US 2002/0036600 A1
(43) Pub. Date: Mar. 28, 2002

(54) Display device

(75) Inventor: Hendrikus Bernardus Van Den Brink, Eindhoven (NL)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 09/925,342

(22) Filed: Aug. 9, 2001

(30) Foreign Application Priority Data
Aug. 11, 2000 (EP) 00202830.6

(51) Int. Cl. G09G 3/04

(52) U.S. Cl. 345/33

(57) ABSTRACT

A display device of the index type comprises a dual set of tracking electrodes (7a, 7b) which extend substantially parallel to each other and are separated by non-conducting zones (14) undulating in the parallel direction 1.

The invention relates to a display device comprising a cathode ray tube having a display window, means for generating one or more electron beams, means for deflecting the electron beams across the display window and means for indicating the position(s) of the electron beam(s) on the display window and means for controlling the deflection of the electron beam(s) as a function of the indicated position.

In general, a display device has a display window. The image is displayed on the display window. A known type of cathode ray tube is the so-called index type. The index type cathode ray tubes form an alternative to the standard shadow mask cathode ray tubes. Cathode ray tubes of the index type have means for indicating the position(s) of the electron beam for a single electron beam index tube or the electron beams for an index tube in which more than one electron beam is generated.

The means for indicating the position generate a signal or signals indicative of the position(s). Said signal or signals derived therefrom are used to control and steer the deflection of the electron beams. Such a tracking system (i.e. finding and steering the position(s) of the electron beam(s)) allows accurate positioning of the electron beam(s). The great advantage of the index type cathode ray tube over the standard shadow mask type CRTs is the fact that there is no need for a shadow mask. Despite the relative simplicity of the design of the index tube compared to the standard shadow mask design, in which respect in particular the absence of the heavy, costly and bulky shadow mask constitutes a great advantage and the more so for the larger sizes of cathode ray tubes, index tubes have not yet replaced the shadow mask tubes.

One of the major obstacles in realising index tubes is the accuracy and reliability with which the tracking system is able to track and steer the electron beams.

It is an object of the invention to provide a display device of the type described in the opening paragraph, having an improved ability to determine the position(s) of the electron beam(s).

To this end, a display device in accordance with the invention is characterized in that the means for indicating the position(s) of the electron beam(s) comprise a first set of interconnected electrodes extending substantially parallel to each other and to a scanning direction, a second set of interconnected electrodes extending substantially parallel to each other and to the first set of electrodes, the electrodes of the first and second sets being adjacent to each other and separated by a non-conducting zone having a centre line showing a periodic undulation along the parallel direction.

The invention provides a display device in which the means for indicating the position are relatively simple, yet offer a high reliability and accuracy.

As an electron beam scans across the screen and the non-conducting zone, two signals are generated, one on the first set of electrodes and one on the second set of electrodes. Both these signals have an AC component given by the spatial frequency (wavelength) of the undulation and the speed of scanning. The fact that there are two AC signals greatly increases the reliability. If one of the signals, for whatever reason, misses or becomes dubious as far as accuracy is concerned, the other signal can still be used. Comparison of the two signals offers increased information on the position(s) of the electron beam(s) as well as possibly information on the accuracy of one or either of the signals. AC signals can be transferred more easily than DC signals from within the tube to outside the tube. This can be done, for instance, via the cathode contacts.

Since the centre line of the non-conducting zone shows a periodic undulation, i.e. going to and fro in between the electrodes at either side of the non-conducting zone, the AC signals on the sets of electrodes will be substantially in counter phase. This allows a difference and/or a sum signal to be obtained. The difference signal is larger than the signals on both sets of electrodes. Furthermore, taking the difference signal will automatically reduce or delete any stray signal components (for instance, due to pick-up) that are the same for both sets of electrodes. Thus, the signal-to-noise ratio as well as the reliability can be increased as compared to device in which only one signal is generated. The sum signal will be zero, when the electron beam(s) is or are perfectly aligned. Regulating to a zero signal can be done very accurately, because the signal, although being small, is very sensitive to any deviation.

Preferably, the spatial frequency of the undulation of adjacent non-conducting zones is different. This allows signals from electron beams scanning adjacent non-conducting zones to be distinguished. This is of particular importance when adjacent non-conducting zones correspond to phosphor regions of different colours.

Preferably, the electrodes comprise a metallic part of straight configuration flanked at a side adjacent an adjacent electrode by a transparent conducting part showing an undulated form. The undulating pattern of the non-conducting zones is preferably not visible in the image. Undulating structures can cause Moire patterns, even if they are not directly visible to the naked eye. In these preferred embodiments, the metallic non-transparent parts are of a straight form, the undulating parts of the electrodes are transparent and thus do not cause or hardly cause Moire patterns. In principle, it is possible that the whole of the electrodes is made of transparent conducting materials. This would give the advantage of prevention or reduction of Moire patterns (and thus form in itself a preferred embodiment) but, as stated above, the electrodes preferably comprise a central metallic part. The conductance of this part is much greater than that of transparent conducting materials (such as ITO, ATO or substances comprising organic conducting materials). Preferably, the transparent conducting materials comprise inorganic conducting materials. Although organic conducting materials can be used, they are more prone to gradual degradation due to electron bombardment.

Preferably, the display device comprises phosphor lines extending under the non-conducting areas. In such embodiments, the phosphor lines are parallel to the scanning direction. Although the invention can be used within its broadest concept in embodiments in which the scanning direction is transverse to the phosphor lines as well as in embodiments in which the phosphor lines extend along the scanning direction, the invention provides its greatest advantage in embodiments in which the phosphor lines extend in parallel with and at least partially under the non-conducting zones. In such embodiments, there is a one-to-one relationship between the position of an electron beam(s) and the color rendition.

These and further aspects of the invention will be explained in greater detail by way of example and with reference to the accompanying drawings, in which

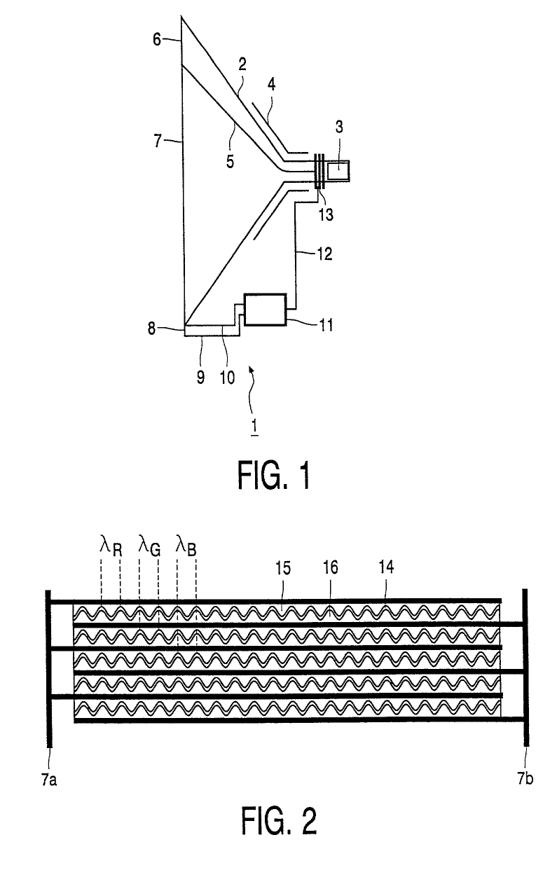

FIG. 1 shows schematically a display device in accordance with the invention.

FIG. 2 shows schematically the two sets of electrodes used in a display device in accordance with the invention.

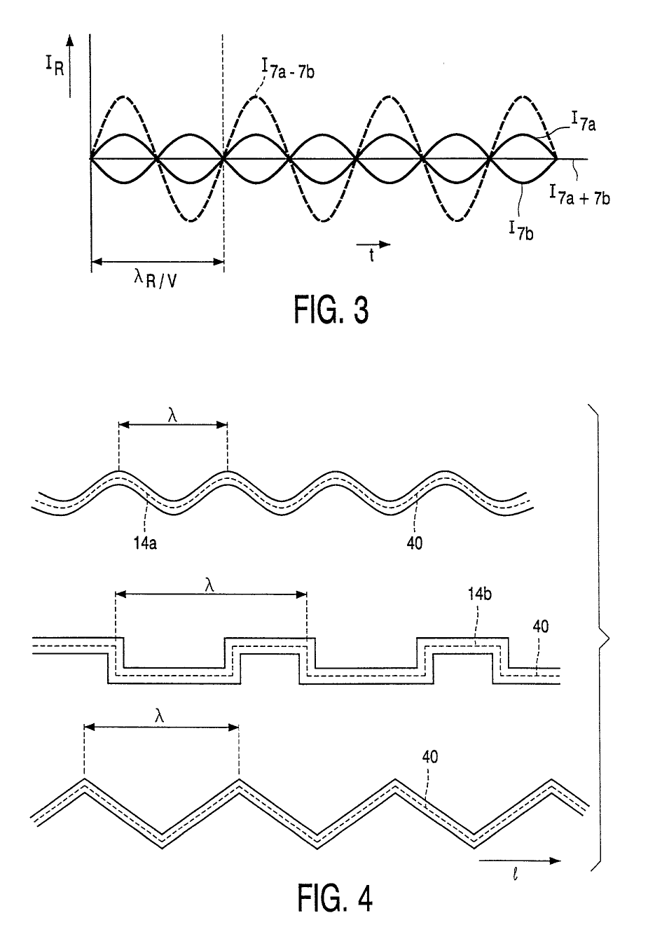

FIG. 3 shows schematically the two signals emanating from the two sets of electrodes when a beam is scanned across the non-conducting zone.

FIG. 4 shows several different arrangements for the sets of electrodes.

The Figures are not drawn to scale. In general, like reference numerals refer to like parts.

FIG. 1 shows schematically a display device 1 comprising a cathode ray tube 2. The cathode ray tube comprises an evacuated envelope accomodating a means for generating one or more electron beams (for instance, an electron gun 3). The display device comprises a means 4 for scanning the electron beam(s) 5 across a phosphor screen on the inner side of window panel 6. Said means may be a deflection unit placed around the evacuated envelope. A pattern of electrodes as further shown in FIG. 2 is arranged on the inner side of the display window 6. Means 8 are provided to transfer the AC signals from within the tube to outside the tube. AC signals can be more easily transferred (since they can be transferred by inductive means such as a capacitance) from the inside to the outside. Via two leads 9 and 10, the signals are applied to a device 10 for signal interpretation and generation of a feedback signal, which feedback signal is sent via lead 12 to correction means (such as, for instance, correction coils 13). The correction coils may comprise sub-coils for generating dipolar, quadrupolar, sixpolar and higher order electromagnetic fields to correct the position of the electron beams.

FIG. 2 shows the electrode pattern 7 in more detail. The electrode pattern comprises two sets of electrodes 7a and 7b. Each set comprises a number of electrodes which are parallel to each other and to the electrodes of the other set. The electrodes are separated by non-conducting zones 14, the centre line (i.e. the line through the points at equal distance from the nearest electrodes) of which forms an undulating line (see FIGS. 4a to 4d). In this preferred embodiment, the electrodes comprise a central straight opaque electrode part 15 (for instance, made of metal) and at each side of said central part 15 a transparent part 16 made from a transparent conducting material such as e.g. ITO or ATO. Preferably, the position of the opaque part corresponds to a black matrix. In such an arrangement, the opaque part does not influence the light output, because the light output of a black matrix part of a phosphor screen is zero. The first (from the top) zone 14 covers red phosphor areas and has a spatial wavelength of?_{R}. Thus a red phosphor line (which could be an unbroken line or an alignment of areas) lies under the first non-conducting zone 14. The second (from the top) zone 14 covers green phosphor areas and has a spatial wavelength of ?_{G}. The third (from the top) zone 14 covers blue phosphor areas and has a spatial wavelength of ?_{B}. In this preferred embodiment, the spatial wavelengths differ, i.e. ?_{R}?_{G}?_{B}. Since the wavelengths differ, the tracking signals for the different phosphors on electrodes 7a and 7b have a different frequency and can thus be distinguished from each other. Using transparent parts 16 has the advantage (over using fully opaque electrodes) that Moire interference between the image displayed and the electrode structure is reduced or eliminated.

FIG. 3 shows schematically the signals on electrodes 7a and 7b. The vertical axis denotes the signals I_{R} in arbitrary units, i.e. for the situation when an electron beams scans across the a ‘red’ zone 14, and the horizontal axis denotes time t in arbitrary units. Only the AC component is shown. Using capacitive coupling means, it is possible to measure such AC components on the electrodes 7a and 7b from outside the tube. Three signals are shown, the signal on electrode 7a (I₇ₐ), the signal on electrode 7b (I_{7b}) and the difference signal (I_{7a-7b}). Since the signals on electrodes 7a ad 7b are substantially in counter-phase (due to the meandering feature of zone 14) the difference signal is substantially twice as large as each signal per se. This increases the signal-to-noise ratio and thereby the tracking accuracy. The sum signal (which should be zero and is indicated in FIG. 3 by I_{7a+7b}) could also be monitored. This sum signal has the advantage that, although the signal itself is small, the deviations in the signal are most sensitive to any deviation in the position of the electron beam(s). Apart from this effect, the following effect also occurs often. AC stray signals (such as AC signals picked-up by the electrode structure as a sort of antenna) will often be substantially in phase for electrodes 7a and 7b. Taking the difference substantially eliminates such stray signals or at least greatly reduces them. This also increases the signal-to-noise ratio. Given the fact that two signals are produced, even if one of the electrodes malfunctions, the system would still function (be it with possibly a reduced signal-to-noise ratio). Such effects cannot be obtained in any system in which a single signal per scanning electron beam is produced. When the electron beam passes across the zone, the form of the zone 14 produces signals in electrodes at opposite sides of the zone, which signals are in counterphase. Thus the counter-phase characteristic of the signals allows a substantial signal-to-noise increase and thereby an improved tracking capability.

FIG. 4 shows schematically a number of possible forms for zones 14. For each of these zones, the centre line 40 along the parallel direction 1 is a periodic undulation ?.

It will be clear that many variations are possible within the frame work of the invention. For instance, there could be a dual set of electrodes for the upper part of the screen and one for the bottom part. The spatial wavelength could also be different for different parts of the screen so as to establish roughly the position of the electron beam(s) on the screen. Bandpass filters may be and are preferably used in device 11 to filter signals so as to increase the signal-to-noise ratio.

In summary, the invention may be described as follows.

A display device of the index type comprises a dual set of tracking electrodes (7a, 7b) which extend substantially parallel to each other and are separated by non-conducting zones undulating in the parallel direction 1.

1. A display device (1) comprising a cathode ray tube device having a display window (6), means (3) for generating one or more electron beams (5), means (4) for deflecting the electron beam(s) (5) across the display window (6) and means for indicating the position(s) of the electron beam(s) on the display window (7, 7a, 7b, 8, 9, 10, 11) and means (13) for controlling the deflection of the electron beams as a fimction of the indicated position, characterized in that the means for indicating the position(s) of the electron beam(s) comprise a first set of interconnected electrodes (7a) extending substantially parallel to each other and to a scanning direction, a second set of interconnected electrodes (7b) extending substantially parallel to each other and to the first set of electrodes, the electrodes of the first and second sets being adjacent to each other and separated by a non-conducting zone (14) having a centre line (40) showing a periodic undulation (?) along the parallel direction (1).

2. A display device as claimed in claim 1, characterized in that the electrodes comprise a central metallic part (15) and parts (16) facing the other electrodes which are made of a transparent conducting material.

3. A display device as claimed in claim 2, characterized in that the central metallic part (15) is substantially straight.

4. A display device as claimed in claim 1, characterized in that the means for indicating the position comprise a circuit (11) for generating a signal equivalent to or derived from the difference (I _{7a-7b}) of the signal on or through the first and second sets of electrodes.

5. A display device as claimed in claim 1, characterized in that the means for indicating the position comprise a circuit (11) for generating a signal equivalent to or derived from the sum (I_{7a+7b}) of the signal on or through the first and second sets of electrodes.

6. A display device as claimed in claim 1, characterized in that the display device comprises phosphor lines extending parallel to and under the non-conducting zones (14).
